(19) United States
(12) Patent Application Publication
(10) Pub. No.: US 2010/0002441 A1
(43) Pub. Date: Jan. 7, 2010

(54) Aspherical lens for LED

(75) Inventor: Yen-Wei Ho, Taichung (TW)

Correspondence Address: GENIUS ELECTRONIC OPTICAL CO., LTD., P. O. Box 215,, TAICHUNG, 40099, TW

(73) Assignee: GENIUS ELECTRONIC OPTICAL CO., LTD.

(21) Appl. No.: 12/230,642

(22) Filed: Sep. 3, 2008

(30) Foreign Application Priority Data
Jul. 1, 2008 (TW) 097124665

(51) Int. Cl. F21V 14/06; F21V 5/04

(52) U.S. Cl. 362/277; 362/311.01

(57) ABSTRACT

An illuminate device with an optical lens includes an aspherical lens and a LED. The aspherical lens, which has a flat end and an aspheric convex end, is held at the distance between 13.5 to 16.3 mm from the light center of the LED to the vertex of the aspheric surface of the lens. Light emitted from the LED enters the flat end of the lens and is refracted by the aspheric end of the lens to create a zoomable spot. An axial cross-section curve of the aspherical lens contents with a set of rectangular coordinates, which are (12,8.00), (11,8.05), (10,8.20), (9,8.44), (8,8.79), (7,9.25), (6,9.82), (5,10.51), (4,11.33), (3,12.29), (2,13.42), (1,14.75), (0,16.30), (−1,14.75), (−2,13.42), (−3,12.29), (−4,11.33), (−5,10.51), (−6,9.82), (−7,9.25), (−8,8.79), (−9,8.44), (−10,8.20), (−11,8.05), (−12,8.00).

### FIELD OF THE INVENTION

The present invention generally relates to the field of optical devices and more specifically to torches and lamps, and methods for optical lens with LED to project the preferred included angles of light beams.

### BACKGROUND OF THE INVENTION

In the field of the torch and the lamp, LED has been used as a light emitter with less electricity and high illuminative performance. A torch usually set a convex lens in front of a LED to focus the light beam in a narrow included angle for an enhance light spot. In the prior art a convex lens they used was a spherical lens. But a spherical lens could not focus the light emitted from a LED to an optimum parallel light beam. Therefore, the luminosity of the light spot would weaken very quickly in a short distance.

Accordingly, in view of the foregoing, there is currently a need in the art for improving devices for focusing light from a LED to cast in a preferred distance and still getting an optimum luminosity.

### SUMMARY OF THE INVENTION

The present invention, which is an optical device, includes an aspherical lens and a LED. The aspherical lens has a convex end and a flat end. The LED as the light source holds at default distances on the optical axis of flat end of the lens. As the lens shifting in the default distances to the LED, projects a beam in a certain range of the included angle from a focus spot to a wide spot.

For above purpose, an optical device includes an aspheric lens and a LED. On the LED emitting center axis sets an aspheric lens in front of the LED. The aspheric lens has a flat end and an aspheric convex end. An axial cross-section curve of the aspherical lens contents with a set of rectangular coordinates, which are (12,8.00), (11,8.05), (10,8.20), (9,8.44), (8,8.79), (7,9.25), (6,9.82), (5,10.51), (4,11.33), (3,12.29), (2,13.42), (1,14.75), (0,16.30), (−1,14.75), (−2,13.42), (−3,12.29), (−4,11.33), (−5,10.51), (−6,9.82), (−7,9.25), (−8,8.79), (−9,8.44), (−10,8.20), (−11,8.05), (−12,8.00). The lens is held at places between 13.5 to 16.3 mm from the light center of the LED to the vertex of the aspheric surface of the lens. Light emitted from the LED enters the flat end of the lens and is refracted through the aspheric end of the lens to create a zoom able spot.

However, the thickness of the aspherical lens, measuring from the vertex of the convex end to the center of the flat end, sets in length between 6 to 10 mm. When zooming in or out the proportion of the aspherical lens can be equivalence.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of the rectangular coordinate of the relative assembly for a prefer embodiment;

FIG. 2 is a table of a set of rectangular coordinates for the curve line on an axial cross-section of the convex end of the aspherical lens.

FIG. 3 is a diagram of the LED shifting at a prefer distance to the lens for a minimum included angle of the emitting light.

FIG. 4 is a diagram of the LED shifting at a prefer distance to the lens for a wide included angle of the emitting light.

### DETAILED DESCRIPTION OF THE INVENTION

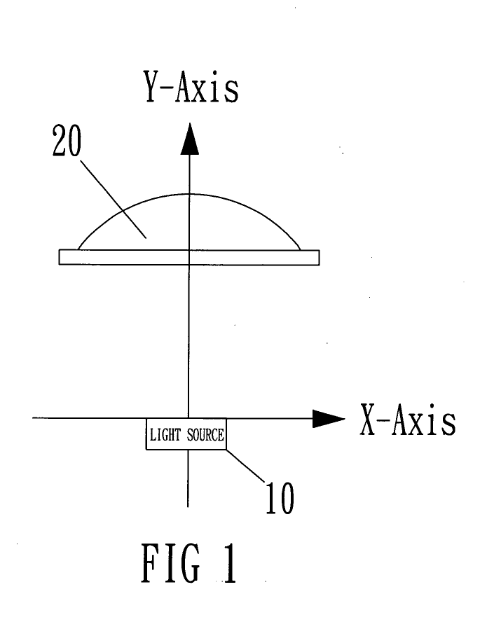

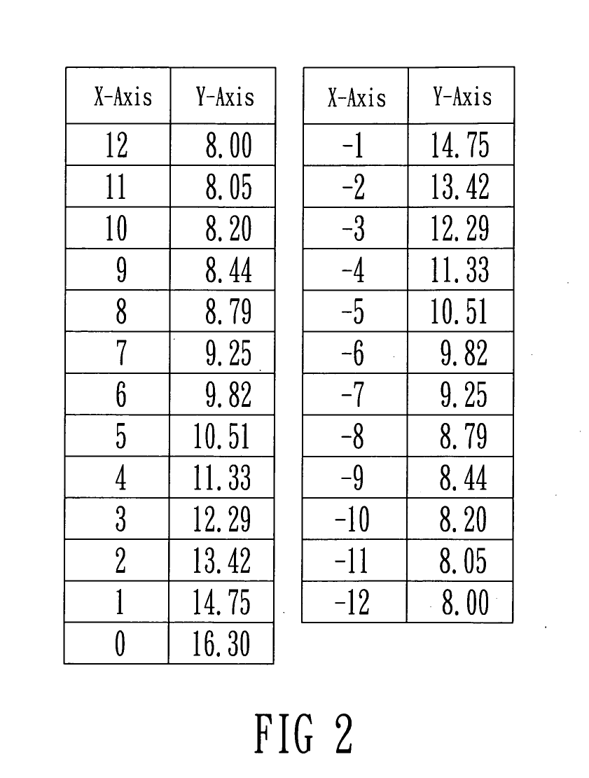

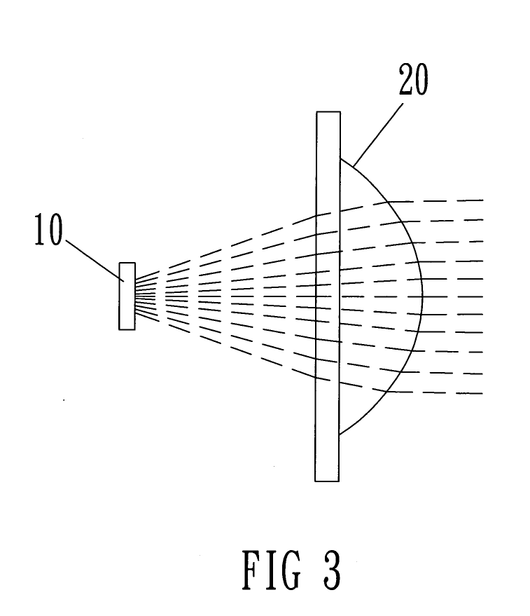

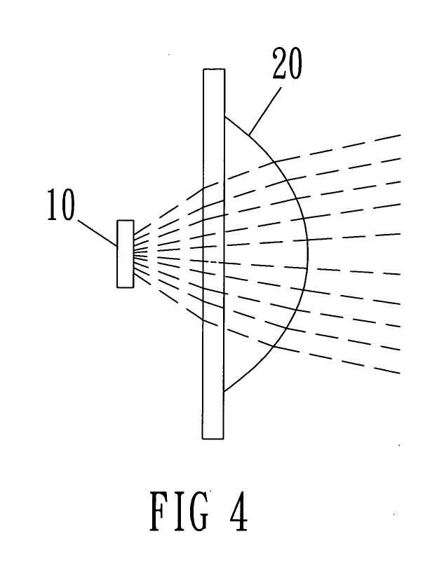

In the FIG. 1, the prefer embodiment of the present invention comprises: a LED 10 placed on a axis of light at a preferred range of distance which is between 13.5 to 16.3 mm from the LED 10 light center to the vertex of the convex end of an aspherical lens 20, and an aspherical lens 20 set one convex end which is an aspheric surface as a light exiting end and one flat end as a light entering end. The thickness of the aspherical lens 20, measuring from the vertex of the convex end to the center of the flat end, is set in the range of 6 to 10 mm for the optimum performances. For definition of the curve on an axial cross-section of the convex end of the aspherical lens 20 sets the center of the LED 10 at the origin of the rectangular coordinates, (0,0). Therefore, as in the FIG. 2, a set of coordinates of the curve are (12,8.00), (11,8.05), (10,8.20), (9,8.44), (8,8.79), (7,9.25), (6,9.82), (5,10.51), (4,11.33), (3,12.29), (2,13.42), (1,14.75), (0,16.30), (−1,14.75), (−2,13.42), (−3,12.29), (−4,11.33), (−5,10.51), (−6,9.82), (−7,9.25), (−8,8.79), (−9,8.44), (−10,8.20), (−11,8.05), (−12,8.00). By those curves following above coordinates, the acceptable curvature values are between ±1 mm. As in the FIG. 3, an included angle of the beam is minimum when the emitting center of the LED 10 sets its position on the axis of the aspherical lens 20 at 16.3 mm from the vertex of convex of the aspherical lens 20. As in the FIG. 4, an included angle of the beam is the optimum wide angle when the emitting center of the LED 10 sets its position on the axis of the aspherical lens 20 at 13.5 mm from the vertex of convex of the aspherical lens. However, as zooming in or out the proportion of the aspherical lens 20 can get equivalence. The coordinates of the curve of aspherical lens 20 content the following multinomial formula.

$$sag ( ρ ) = \frac{{ρ}^{2} / r}{1 + \sqrt{1 - ( 1 + c ) {( ρ / r )}^{2}}} + d {ρ}^{4} + e {ρ}^{6} + f {ρ}^{8} + g {ρ}^{10} + h {ρ}^{12} … l {ρ}^{20}$$

ρ: where the optic axis is presumed to lie in the Y direction, and sag( p) is the Y-component of the displacement of the surface from the vertex, at distance ρ from the axis.
r: defined to be the radius of curvature of the surface.
c: is the conic constant.
d,e,f,g,h,l: are the coefficients to describe the deviation of the surface from a conic surface.

If the radius of curvature of the aspherical lens 20 sets between 3 to 10 mm, the curve of an axial cross-section will place at between two parabolas. For the optimum performance of the light spot, the center of the LED 10 can place on the axial of the aspherical lens 20 at the distance to the vertex of the aspherical lens 20 between 13.5 to 16.3 mm.

1. An optical device for illumination, the optical device comprising:
a light emitter placed at the origin of the rectangular coordinate, and
a lens with the rotative symmetry having a flat end and a convex end, wherein the rectangular coordinates of a curve on the axial convex cross-section of the lens are as following: (12,8.00), (11,8.05), (10,8.20), (9,8.44), (8,8.79), (7,9.25), (6,9.82), (5,10.51), (4,11.33), (3,12.29), (2,13.42), (1,14.75), (0,16.30), (−1,14.75), (−2,13.42), (−3,12.29), (−4,11.33), (−5,10.51), (−6,9.82), (−7,9.25), (−8,8.79), (−9,8.44), (−10,8.20), (−11,8.05), (−12,8.00) and its curvatures set between 1 to −1 mm, and therefore a beam of the light emitter refracting through the convex end of the lens to perform a minimum included angle.

2. An optical device in accordance with claim 1, wherein the thickness of the lens, measuring from the vertex of the convex end to the flat end, sets the length between 6 to 10 mm.

3. An optical device in accordance with claim 1, wherein the light emitter places at between 13.5 to 16.3 mm from the center of the light emitter to the vertex of the convex end of the lens on the optic axis of the lens for the optimum performance of the light spot.

4. An optical device in accordance with claim 1, wherein the light emitter is a LED.

5. An optical device in accordance with claim 1, wherein the lens zooms its proportion for the equivalence of optical effect.

6. An optical device for illumination, the optical device comprising:
a lens with the rotative symmetry having a flat end and a convex end, and
a light emitter placed at the distance between 13.5 to 16.3 mm from the center of the light emitter to the vertex of the convex end of the lens on the optic axis of the lens for changing the included angles of the beam that refract through the convex end of the lens.

7. An optical device in accordance with claim 6, wherein the light emitter is a LED.

8. An optical device in accordance with claim 6, wherein the convex end of the lens is a rotative symmetrical aspherical surface.

9. An optical device in accordance with claim 6, wherein the thickness of the lens, measuring from the vertex of the convex end to the flat end, sets the length between 6 to 10 mm.

10. An optical device in accordance with claim 6, wherein a cross-section curve of the convex end contents the following rectangular coordinates: (12,8.00), (11,8.05), (10,8.20), (9,8.44), (8,8.79), (7,9.25), (6,9.82), (5,10.51), (4,11.33), (3,12.29), (2,13.42), (1,14.75), (0,16.30), (−1,14.75), (−2,13.42), (−3,12.29), (−4,11.33), (−5,10.51), (−6,9.82), (−7,9.25), (−8,8.79), (−9,8.44), (−10,8.20), (−11,8.05), (−12,8.00) and its curvatures set between 1 to −1 mm.

11. An optical device for illumination, the optical device comprising:
a lens with the rotative symmetry having a flat end and a convex end with thickness between 6 to 10 mm, measuring from the vertex of the convex end to the center of the flat end, wherein a axial cross-section curve of the convex end contents the following rectangular coordinates: (12,8.00), (11,8.05), (10,8.20), (9,8.44), (8,8.79), (7,9.25), (6,9.82), (5,10.51), (4,11.33), (3,12.29), (2,13.42), (1,14.75), (0,16.30), (−1,14.75), (−2,13.42), (−3,12.29), (−4,11.33), (−5,10.51), (−6,9.82), (−7,9.25), (−8,8.79), (−9,8.44), (−10,8.20), (−11,8.05), (−12,8.00) and its curvatures set between 1 to −1 mm, and a light emitter placed at the distance between 13.5 to 16.3 mm from the center of the light emitter to the vertex of the convex end of the lens on the optic axis of the lens for changing the included angles of the beam.

12. An optical device in accordance with claim 11, wherein the light emitter is a LED.
